(19) United States
(12) Patent Application Publication
(10) Pub. No.: US 2010/0031540 A1
(43) Pub. Date: Feb. 11, 2010

(54) Environmentally Friendly Publication And Method Of Manufacturing Same

(75) Inventor: Clifford Alan Koehler, Stilwell, KS (US)

Correspondence Address: LATHROP & GAGE LLP, 2345 GRAND Boulevard, SUITE 2400, KANSAS CITY, MO, 64108, US

(73) Assignee: Andrews McMeel Publishing LLC

(21) Appl. No.: 12/188,435

(22) Filed: Aug. 8, 2008

(51) Int. Cl. G09D 3/04

(52) U.S. Cl. 40/119

(57) ABSTRACT

Publications (e.g., calendars) and methods of manufacturing same are set forth herein. A publication according to an embodiment includes a plurality of flexible pages operatively coupled together along a spine. The pages are of generally equal size, and a substrate is operatively coupled to the pages. A stiff sheet is coupled to the substrate, and the stiff sheet and substrate are collectively of generally equal size as the pages. The substrate is configured for removal from the pages. According to another embodiment, a wall calendar to be shipped and retailed without individual packaging includes a plurality of sheets having indicia and being coupled together along a spine. A substrate is coupled to the sheets along the spine, and a stiff sheet is coupled to the substrate. The substrate is configured for complete removal from the pages after retail. The wall calendar is never individually wrapped before being sold at retail.

### BACKGROUND

Novel publications and methods of manufacturing publications are set forth herein, as will be evident from reviewing the description below and the accompanying drawings.

### SUMMARY

A publication according to an embodiment includes a plurality of flexible pages operatively coupled together along a spine. The pages are of generally equal size, and a substrate is operatively coupled to the pages. A stiff sheet is coupled to the substrate, and the stiff sheet and substrate are collectively of generally equal size as the pages. The substrate is configured for removal from the pages.

A calendar according to an embodiment includes a plurality of sheets that are coupled together along a spine by at least one staple. The sheets include indicia. A substrate is coupled to the sheets by the at least one staple, and the substrate is configured for removal from the pages. A stiff sheet is coupled to the substrate. The calendar is never individually wrapped before being sold at retail.

According to an embodiment, a wall calendar to be shipped and retailed without individual packaging includes a plurality of sheets having indicia and being coupled together along a spine. A substrate is coupled to the sheets along the spine, and a stiff sheet is coupled to the substrate. The substrate is configured for complete removal, along with the stiff sheet, from the pages after being sold at retail. The wall calendar is never individually wrapped before being sold at retail.

### BRIEF DESCRIPTION OF THE DRAWINGS

FIG. 1 is a front perspective view of an environmentally friendly publication according to an embodiment.

FIG. 2 is a rear perspective view of the environmentally friendly publication of FIG. 1.

FIG. 3 is a perspective view of a stiffening element from the environmentally friendly publication of FIG. 1.

FIG. 4 is an exploded view of the stiffening element of FIG. 3.

FIG. 5 is a side view of the environmentally friendly publication of FIG. 1.

FIG. 6 is a side view of a stack of environmentally friendly publications according to the embodiment of FIG. 1.

FIG. 7 depicts an exemplary method of constructing an environmentally friendly publication.

### DETAILED DESCRIPTION

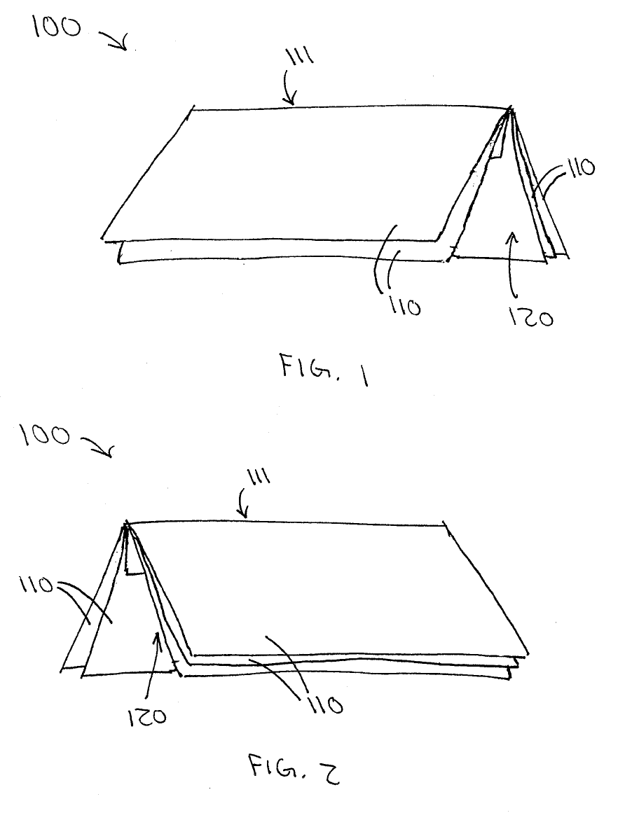

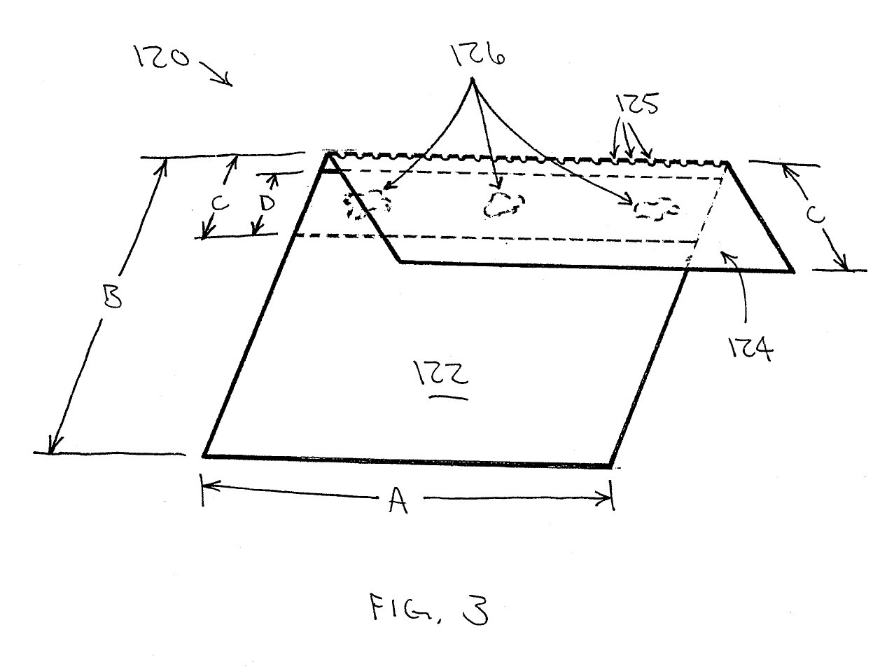

FIGS. 1 and 2 show one embodiment of an environmentally friendly publication 100 (e.g., a calendar, magazine, etc.). The environmentally friendly publication 100 has a plurality of pages 110 and a stiffening element 120. The pages 110 are coupled together along a spine 111, may be constructed of paper or any other appropriate material, and may include various indicia, including, text, pictures, charts, etc. A currently preferred material for the pages 110 is recycled paper, though other materials are clearly acceptable, and the indicia may be placed on the pages 110 through automated printing methods or any other appropriate method, whether currently existing or developed in the future. In some embodiments, the indicia and the method of adding the indicia are environmentally friendly. For example, soy and/or vegetable inks may be used, and the printing process may utilize solar, wind, or other environmentally friendly power source. While four pages 110 are shown in FIGS. 1 and 2, it should be understood that more or fewer pages 110 may be included. In addition, though pages 110 are shown to open upwardly in FIGS. 1 and 2, it should be understood that the pages 110 may alternately open to the side like a traditional book.

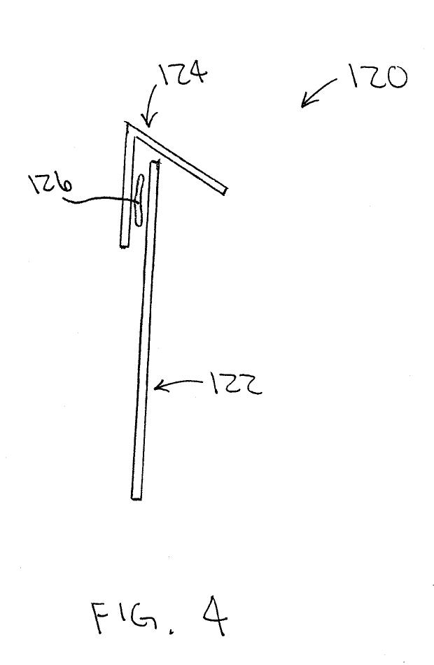

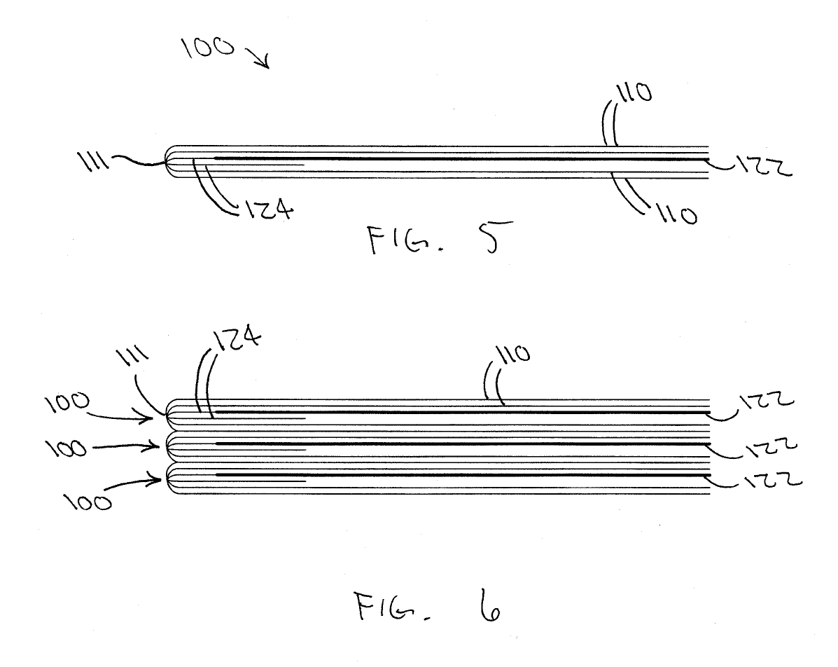

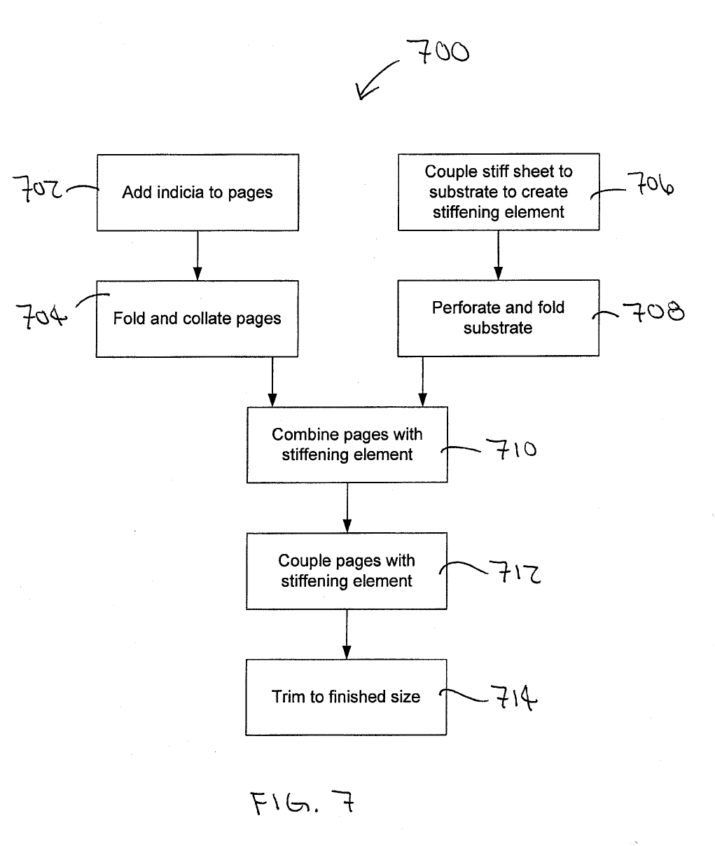

The stiffening element 120, which is shown in detail in FIGS. 3 and 4, may be operatively coupled to the pages 110 to keep the pages 110 generally planar or “flat” (e.g., as shown in FIGS. 5 and 6). Maintaining the pages 110 generally flat may be advantageous for various reasons, including for shipping and display, for example. The stiffening element 120 may include a stiff sheet 122 coupled to a substrate 124, such as by adhesive 126. The substrate 124 may be constructed of the same material as the pages 110 or any other appropriate material, and the stiff sheet 122 is constructed of a material that is more rigid than the pages 110 (e.g., chipboard, cardboard, a corrugated sheet, etc.). In some embodiments, the stiff sheet 122 and/or the substrate 124 are constructed of recyclable material, and the adhesive 126 is an environmentally friendly adhesive.

The stiffening element 120 may be coupled to the pages 110 by one or more staple, adhesive, and/or any other appropriate fastening method, and the stiffening element 120 may be placed in the center of the pages 110 (i.e., as a centerfold, as shown throughout the drawings), otherwise between the pages 110, or outside the pages 110 (such as a cover). Especially by placing the stiffening element 120 in the center of the pages 110, the stiffening element 120 may be relatively easy to separate from the pages 110 and indicia on the outer pages 110 may be viewed while the stiffening element 120 is operatively coupled to the pages 110. To ease the separation of the stiffening element 120 from the pages 110, the substrate 124 may include perforations 125 (FIG. 3), be scored, or be otherwise weakened. The substrate 124 may be folded (as shown throughout the drawings) to allow the substrate 124 to be easily coupled to the pages 110.

The support provided by the stiffening element 120 (i.e., by the stiff sheet 122) may eliminate the need for additional packaging in and around the publication 100, including plastic wrapping (i.e., shrink wrapping). Eliminating the additional packaging may provide environmental benefits and may additionally allow potential customers to flip through the pages 110 of the publication 100 before purchasing the publication 100, which may in turn increase sales and reduce unsold copies and returns. Unsold copies are generally either returned to the publisher or destroyed at the retail site, which may negatively impact the environment.

FIG. 7 depicts an exemplary method 700 of constructing the environmentally friendly publication 100. At step 702, indicia is placed on pages 110 (e.g., by a printer), and the pages 110 are folded and collated at step 704. In some embodiments, indicia is placed on both sides of pages 110. At step 706, the stiffening element 120 is constructed by adhering the stiff sheet 122 to the substrate 124 using the adhesive 126. At step 708, the substrate 124 is perforated and folded. At step 710, the stiffening element 120 is combined with the pages 110. At step 712, the pages and the stiffening element 120 are coupled together, such as by at least one staple. At step 714, the pages 110 and the stiffening element 120 are trimmed to the finished (i.e., final) size, as needed. It should be appreciated that the steps set forth above are exemplary and that may steps may be performed in various orders. For example, the substrate 124 may be perforated before the stiff sheet 122 is adhered to the substrate 124; the pages 110 and/or the substrate 124 may be folded after being coupled together; the stiff sheet 122 may be adhered to the substrate 124 after the substrate 124 is coupled to the pages 110; step 704 may be combined with step 710; etc.

The pages 110 and the stiffening element 120 may be various sizes, though it may be preferable that the stiffening element 120 is sized to correspond to the pages 110. For example, in one exemplary configuration in which the publication 100 is a twelve inch by twelve inch calendar, pages 110 are approximately twelve inches by twelve inches, the stiff sheet 122 is approximately twelve inches (denoted A in FIG. 3) by eleven and a half inches (denoted B in FIG. 3), each side of the folded substrate 124 is approximately three inches (denoted C in FIG. 3), and the stiff sheet 122 and substrate 124 overlap approximately two and a half inches (denoted D in FIG. 3).

Those skilled in the art appreciate that variations from the specified embodiments disclosed above are contemplated herein and that the described embodiments are not limiting. The description should not be restricted to the above embodiments, but should be measured by the following claims.

We claim:

1. A publication, comprising:
a plurality of flexible pages operatively coupled together along a spine, the pages being of generally equal size;
a substrate operatively coupled to the flexible pages, the substrate being configured for removal from the pages; and
a stiff sheet coupled to the substrate, the stiff sheet and substrate collectively being of generally equal size as the pages.

2. The publication of claim 1, wherein the stiff sheet is constructed of at least one of chipboard, cardboard, and a corrugated sheet.

3. The publication of claim 1, wherein the pages are not wrapped in packaging.

4. The publication of claim 1, wherein the substrate and stiff sheet are located in the center of the pages as a centerfold.

5. The publication of claim 1, wherein at least one staple couples the pages together along the spine and couples the substrate to the pages.

6. The publication of claim 1, wherein:
the pages are constructed of recycled paper;
the stiff sheet is constructed of at least one of chipboard, cardboard, and a corrugated sheet;
the pages include environmentally friendly ink;
the substrate and stiff sheet are located in the center of the pages as a centerfold;
at least one staple couples the pages together along the spine and couples the substrate to the pages; and
the publication is never individually wrapped before being sold at retail.

7. A calendar, comprising:
a plurality of sheets having indicia thereon and being coupled together along a spine by at least one staple;
a substrate coupled to the sheets by the at least one staple, the substrate being configured for removal from the pages; and
a stiff sheet coupled to the substrate;
wherein the calendar is never individually wrapped before being sold at retail.

8. The calendar of claim 7, wherein the stiff sheet is constructed of at least one of chipboard, cardboard, and a corrugated sheet.

9. The calendar of claim 7, wherein the substrate and stiff sheet are located in the center of the pages as a centerfold.

10. The calendar of claim 9, wherein:
the pages are of generally equal size; and
the stiff sheet and substrate are collectively of generally equal size as the pages.

11. The calendar of claim 10, wherein:
the stiff sheet and the substrate overlap in a region;
the stiff sheet extends beyond the substrate; and
the substrate extends beyond the stiff sheet.

12. The calendar of claim 7, wherein:
the pages are of generally equal size; and
the stiff sheet and substrate are collectively of generally equal size as the pages.

13. The calendar of claim 7, wherein:
the pages are constructed of recycled paper;
the pages include environmentally friendly ink; and
an environmentally friendly adhesive couples the stiff sheet to the substrate.

14. The calendar of claim 7, wherein the substrate and the pages are constructed of the same material.

15. A wall calendar to be shipped and retailed without individual packaging, comprising:
a plurality of sheets having indicia thereon and being coupled together along a spine;
a substrate coupled to the sheets along the spine, the substrate being configured for complete removal from the pages after being sold at retail; and
a stiff sheet coupled to the substrate;
wherein the wall calendar is never individually wrapped before being sold at retail.

16. The wall calendar of claim 15, wherein the substrate and stiff sheet are located in the center of the pages as a centerfold.

17. The wall calendar of claim 16, wherein:
the pages are of generally equal size; and
the stiff sheet and substrate are collectively of generally equal size as the pages.

18. The wall calendar of claim 15, wherein:
the pages are constructed of recycled paper;
the pages include environmentally friendly ink; and
an environmentally friendly adhesive couples the stiff sheet to the substrate.

19. The wall calendar of claim 15, wherein:
the substrate and the pages are constructed of the same material; and
the stiff sheet is constructed of at least one of chipboard, cardboard, and a corrugated sheet.

20. The wall calendar of claim 15, wherein:
the pages are of generally equal size;
the stiff sheet and substrate are collectively of generally equal size as the pages;
the stiff sheet is constructed of at least one of chipboard, cardboard, and a corrugated sheet; and
adhesive couples the stiff sheet to the substrate.
